(19) United States
(12) Patent Application Publication
(10) Pub. No.: US 2023/0331908 A1
(43) Pub. Date: Oct. 19, 2023

(54) BIODEGRADABLE STRING TRIMMER LINE

(71) Applicant: Green IP, LLC, Green Cove Springs, FL (US)

(72) Inventors: Kelvin T. OKAMOTO, Carmel, IN (US); Robert Neal Alfred HAWKINSON, Orange Park, FL (US)

(73) Assignee: Green IP, LLC, Green Cove Springs, FL (US)

(21) Appl. No.: 18/300,078

(22) Filed: Apr. 13, 2023

Related U.S. Application Data
(60) Provisional application No. 63/332,052, filed on Apr. 18, 2022.

(51) Int. Cl. C08G 63/91

(52) U.S. Cl. CPC C08G 63/916; A01D 34/4168

(57) ABSTRACT

A biodegradable string trimmer line that is formed from a biodegradable aliphatic polyester produced primarily from diacid and diol monomers. The string trimmer line is produced by an extrusion process.

### CROSS REFERENCE TO RELATED PATENT APPLICATIONS

This invention claims priority from U.S. Provisional Application No. 63/332,052, filed Apr. 18, 2022, which is hereby incorporated by reference.

### FIELD OF THE INVENTION

This invention relates to string trimmers and more particularly to a biodegradable string trimmer line.

### BACKGROUND OF THE INVENTION

Line or string trimmers use a plastic string trimmer line or string to trim grasses and other vegetation around obstacles, ditches, and planting beds. The string trimmer line wears out as result of making contact with obstacles. Each time the string trimmer line hits an obstacle while trimming surrounding vegetation, the string trimmer line fractures and slings off microplastic particles into the surrounding area. These microplastics particles shed by the string trimmer line continue to grow in number as the number of trimmings occur over time. These microplastic particles are easily moved by rainfall and end up in ditches, ponds, waterways, lakes, and oceans.

For instance, trimming vegetation around an obstacle once with a string trimmer could create, for example, 10 microplastic particles. If that obstacle is trimmed around 40 times in a year, the trimming could yield up to 400 microplastic particles for just that one obstacle. Over 10 years, that one obstacle could create 4,000 microplastic particles. A property with 100 obstacles could create 400,000 microplastic particles over a 10 year period. That is just one property. There are literally millions of properties and tens of thousands of miles of roadway obstacles that also add to the problem. Those microplastic particles are typically destined for waterways, lakes, and oceans.

In order to address the issue of microplastic particles from string trimmer line left in the environment, string trimmer line can be produced from bioplastics that are soil and water biodegradable. The microplastic particles that are left behind by the string trimmer line will biodegrade over time when coming in contact with microbes in the soil and with water. A commercially available biodegradable string trimmer line is produced from polyhdroxybutyl hexanoate (PHBH), a polyhydroxyalkanoate (PHA), which are generally accepted as being soil and water biodegradable.

### SUMMARY OF THE INVENTION

This invention is an improved biodegradable string trimmer line made from an alternative soil and water biodegradable bioplastic. The string trimmer line made from the alternative soil and water biodegradable bioplastic has improved biodegradability and ductility.

Further objects, features and advantages will become apparent upon consideration of the following detailed description of the invention when taken in conjunction with the drawings and the appended claims.

### DETAILED DESCRIPTION OF THE PREFERRED EMBODIMENT

The material for the biodegradable string trimmer line is a biodegradable aliphatic polyester produced primarily from diacid and diol monomers and described in detail in U.S. Pat. Publication No. 2019/0375932, published Dec. 12, 2019, now Okamoto et al. U.S. Pat. No. 11,608,436, issued Mar. 21, 2023, both of which are incorporated herein by reference in their entirety.

The string trimmer line of the present invention is created by using a standard profile extrusion line with single- or double-strand die. The extrusion barrel, the extrusion die, and melt temperatures are typically 150° C. - 175° C. The cross-section of the die opening can be round, rectangular, triangular, star-shaped or any other cross-sectional shape. Before the polymer pellets are fed to the extruder screw, the pellets must be thoroughly dried at 65° C. - 75° C. for 4-8 hours or until moisture content is ideally less than 400 ppm. The extruder pressure is from 5 MPa - 10 MPa.

For a round string trimmer line produced by the manufacturing process described above, such string trimmer line has a diameter from 1.5 mm - 3.0 mm and a similar thickness for non-round line, e.g. spirals and multiple intertwined strands as well as those with square, rectangular, triangular, and star-shaped cross-sections.

In comparison testing of 2.38 mm diameter round conventional non-biodegradable string trimmer line, an existing commercial biodegradable string trimmer line produced from PHBH, and the inventive string trimmer line, the inventive string trimmer line demonstrates durability versus the commercial biodegradable line. The testing was done along 380 meters of lawn against a chain link fence with pole supports; 4.5 meters of line was wound onto a commercial string trimmer head with a round exit hole. The results are shown in Table 1.

TABLE 1

| Line Tested | Initial Weight | Final Weight | Line Used | # Breaks |
|---|---|---|---|---|
| Traditional | 22.7 g | 18.4 g | 4.3 g (19%) | 0 |
| Commerical Biodegradable Line | 28.3 g | 14.2 g | 14.1 g (50%) | 8 |
| Inventive Biodegradable Line | 28.3 g | 22.7 g | 5.6 g (20%) | 0 |

The microplastic particles released from the string trimmer line are biodegradable in soil and in water. For soil, the material fully biodegrades in less than 90 days per ASTM D5988. For water, the material biodegrades to greater than 90% 451 days per ASTM D6691.

While this invention has been described with reference to preferred embodiments thereof, it is to be understood that variations and modifications can be affected within the spirit and scope of the invention as described herein and as described in the appended claims.

I claim:

1. A biodegradable string trimmer line comprising at least one biodegradable aliphatic polyester produced from diacids selected from the group consisting of adipic acid and succinic acid and combinations thereof and diol monomers selected from the group consisting of ethylene glycol, propanediol, butanediol, and hexanediol wherein the polymer composition is soil biodegradable or water biodegradable.

2. The polymer composition of claim 1 further comprising at least one component selected from the group consisting of plasticizers, flow promoters, polymer processing aids, slip agents, viscosity modifiers, chain extenders, nanoparticles, colorants, anti-microbial agents and combinations thereof.

3. The polymer composition of claim 2, wherein the plasticizer is comprised of polyethylene glycol, sorbitol, glycerine, soybean oil, castor oil, TWEEN 20, TWEEN 40, TWEEN 60, TWEEN 80, TWEEN 85, sorbitan monolaurate, sorbitan monooleate, sorbitan monopalmitate, sorbitan trioleate, sorbitan monostearate, PEG, derivatives of PEG, N,N-ethylene bis-stearamide, N,N-ethylene bis-oleamide, tributyl o- acetyl citrate, ester-based lubricants, and polycaprolactone, polymeric plasticizers such as poly(1,6-hexamethylene adipate), or combinations thereof.

4. The polymer composition of claim 3, wherein the total plasticizer composition is less than 40%.

5. The polymer composition of claim 3, wherein the total plasticizer composition is 5 to 30%.

6. The polymer composition of claim 3, wherein the total plasticizer composition is 10 to 25%.

7. A method for producing a soil or water biodegradable string trimmer line comprising:
a Selecting a biodegradable aliphatic polyesters produced primarily from diacid and diol monomers;
b drying the biodegradable aliphatic polyesters produced primarily from diacid and diol monomers;
c extruding the biodegradable aliphatic polyesters produced primarily from diacid and diol monomers through an extruder line having a barrel and an extruder die with an extruder die opening with a cross-section; and
d collecting the extruded biodegradable string trimmer line on a take up reel.

8. The method of claim 7, wherein the cross-section of the extruder die opening is selected from the group round, square, rectangular, triangular, and star-shaped.

9. The method of claim 8, wherein the string trimmer line comprises spirals and multiple intertwined strands.

10. The method of claim 7, wherein the barrel of the extruder line, the extruder die, and melt temperatures of the biodegradable aliphatic polyesters are maintain 150° C. - 175° C. and extruder line pressure is maintained from 5 MPa - 10 MPa.

11. The biodegradable aliphatic polyester of claim 7, wherein the diacid is selected from the group consisting of succinic acid or adipic acid.

12. The biodegradable aliphatic polyester of claim 7, wherein the diol monomer is selected from the group consisting of ethylene glycol, propanediol, butanediol, and hexanediol.

13. The biodegradable aliphatic polyester of claim 7 further comprising at least one component selected from the group consisting of plasticizers, flow promoters, polymer processing aids, slip agents, viscosity modifiers, chain extenders, nanoparticles, colorants, anti-microbial agents and combinations thereof.

14. The biodegradable aliphatic polyester of claim 13, wherein the plasticizer is comprised of polyethylene glycol, sorbitol, glycerine, soybean oil, castor oil, TWEEN 20, TWEEN 40, TWEEN 60, TWEEN 80, TWEEN 85, sorbitan monolaurate, sorbitan monooleate, sorbitan monopalmitate, sorbitan trioleate, sorbitan monostearate, PEG, derivatives of PEG, N,N-ethylene bis-stearamide, N,N-ethylene bis-oleamide, tributyl o- acetyl citrate, ester-based lubricants, and polycaprolactone, polymeric plasticizers such as poly(1,6-hexamethylene adipate), or combinations thereof.

15. The polymer composition of claim 13, wherein the total plasticizer composition is less than 40%.

16. The polymer composition of claim 13, wherein the total plasticizer composition is 5 to 30%.

17. The polymer composition of claim 13, wherein the total plasticizer composition is 10 to 25%.
